(19) United States
(12) Patent Application Publication
(10) Pub. No.: US 2006/0188326 A1
(43) Pub. Date: Aug. 24, 2006

(54) Coupling for connecting two components

(75) Inventor: Thomas Bayer, Igersheim (DE)

Correspondence Address: ALLEMAN HALL MCCOY RUSSELL & TUTTLE LLP, 806 SW BROADWAY, SUITE 600, PORTLAND, OR, 97205-3335, US

(73) Assignee: Wittenstein AG

(21) Appl. No.: 11/359,245

(22) Filed: Feb. 21, 2006

(30) Foreign Application Priority Data
Feb. 24, 2005 (DE) 102005008920.8

(51) Int. Cl. B25G 3/18

(52) U.S. Cl. 403/321

(57) ABSTRACT

A coupling for connecting two components, such as a drive element to a drive element, transmission, or the like, having a clamping hub and a centering hub which are connected to one another in an axially displaceable manner by at least one bellows, and as additional torsional locking, the clamping hub and centering hub are connected with a positive fit and are radially locked torsionally with respect to one another.

### CROSS-REFERENCE TO RELATED APPLICATIONS

This application claims priority to German Patent Application Serial No. 102005008920.8, filed Feb. 24, 2005, which is hereby incorporated by reference in its entirety for all purposes.

### BACKGROUND AND SUMMARY

The present disclosure relates to a coupling for connecting two components, such as a drive element to a drive element, transmission, or the like, having a clamping hub and a centering hub which are connected to one another in an axially displaceable manner by at least one bellows.

Such couplings are known and available on the market in many forms and designs. They are most commonly known as torsionally rigid compensating couplings which transmit introduced torques from one component to a second component. The coupling is usually attached to a clamping hub and a drive element such as an electric motor, servomotor, or the like, and transmits a torque to any given transmission via a centering hub. A disadvantage of such couplings is that they are subjected to wear, and undergo thermal stress on the drive element for which corresponding expansion of the drive shaft of the drive element must be compensated. Drive elements frequently are not designed with sufficient precision, with the result that corresponding fluctuations of the drive element regarding play, vibration, and thermal expansion over the coupling must be compensated for, or absorbed or intercepted.

As a result, conventional couplings, preferably couplings comprising a clamping hub and centering hub which are connected to one another by a bellows, i.e., a simple or multiple folding bellows, are subjected to a certain amount of wear under excessive stress, in particular axial stress, which deactivates the coupling when the bellows ruptures.

In addition, oscillations of the drive element, imbalances, or the like should not be transmitted to the subsequent transmission element, but, rather, should be intercepted by the coupling. Furthermore, it should be possible for the torque to be transmitted without play from the drive element via the clamping hub to the centering hub, thereby introducing a large torque into a transmission element without play.

The object of the present disclosure is to provide a coupling of the aforementioned type which eliminates the referenced disadvantages and allows a torque to be reliably transmitted, free of play and with absolute precision, in a very simple, economical, and effective manner. In addition, the object is to enable the service life of a coupling to be significantly increased and to ensure transmission of a torque even in the event of a defective bellows, in particular folding bellows, used as a connecting element between a clamping hub and a centering hub.

This object is achieved by the features of the characterizing part of Claim 1 and by the features of equivalent Claim 2.

In the present disclosure, to compensate for a lateral offset of the clamping hub and/or centering hub it has proven to be particularly advantageous to provide a projection on the end face side which engages with a corresponding matching recess or a corresponding projection on the centering hub. In this regard, the radially and preferably circumferentially disposed clamping hub and centering hub are rigidly connected to one another by a bellows or folding bellows so that axial motion between the clamping hub and the centering hub is ensured, and a torque can be transmitted from the clamping hub to the centering hub in a rotationally fixed and play-free manner. A shaft of any given drive element, electric motor, servomotor, or the like, for example, is connected to the clamping hub. To consistently ensure a radial offset and an axial motion between the clamping hub and the centering hub, the projection provided on the end-face side of the clamping hub engages with little play in a corresponding matching recess on the end-face side of the centering hub.

To center the clamping hub with respect to the centering hub, it has been proven to be advantageous to insert in a preferably radially circumferential groove an O-ring which ensures lateral centering of both components with respect to one another.

If the bellows or folding bellows, which is directed radially outward or radially inward and which is able to connect the clamping hub and the centering hub in a coupling on the end-face side, then ruptures as the result of aging or overloading, for example, in the present disclosure it has proven to be particularly advantageous to design the projection from the clamping hub or centering hub as a polygonal or elliptical polygonal profiled piece or the like, which then engages with a correspondingly designed or profiled, matched and aligned recess in the centering hub or clamping hub.

If the bellows ruptures, a redundant system is ensured which is still able to transmit a torque from the clamping hub to the centering hub via radial torsional locking, resulting in a so-called “fail-safe” function.

Radial torsional locking for the parts mutually engaging with a positive fit may be released in various ways. To this end, the projection, which protrudes from the end-face side, preferably of the clamping hub, has an elliptical design and correspondingly engages with an elliptical recess in the centering hub with a positive fit. This likewise produces torsional locking or a so-called radial driver system.

A further embodiment provides that the projection from the clamping hub is designed as a projection which is eccentric with respect to the center axis, and the projection then engages with an eccentrically designed, aligned and substantially matching recess in the centering hub, thereby producing radial torsional locking or a radial driver system if the bellows, in particular folding bellows, ruptures.

Another possibility is for corresponding pin elements, cylinder pins, or alignment pins, for example, to protrude from the end-face side of the clamping hub as projections which engage with correspondingly matched recesses designed as blind holes, openings, or the like, on the end-face side of the centering hub, thereby likewise producing radial torsional locking or a radial driver system as a redundant system with a “fail-safe” function. It is within the scope of the disclosure that other forms of projections, such as pin-like, circular segment-shaped projections, may also provide suitable radial locking.

Furthermore, it has been proven to be advantageous to associate the bellows, in particular folding bellows, and/or a connection point between the clamping hub and centering hub with at least one sensor element which detects the positive-fit engagement of the projection with the recess by friction fit, and/or detects when the bellows or folding bellows is defective or ruptured. This sensor detects a rupture in the bellows coupling, thereby detecting transmission of the torque through the projection of the clamping hub via the recess in the centering hub in a positive-fit manner as a radial driver system. Then, for example, at the next inspection, scheduled maintenance, or the like, the coupling or the bellows may be replaced or repaired. This feature is likewise within the scope of the present disclosure.

### BRIEF DESCRIPTION OF THE FIGURES

Further advantages, features, and particulars of the disclosure result from the following description of preferred exemplary embodiments and with reference to the drawing, which shows the following:

FIG. 1 shows a schematically illustrated longitudinal section of a transmission having an integrated or inserted coupling comprising a clamping hub and a centering hub;

FIG. 2a shows a schematically illustrated longitudinal section of the coupling, comprising the clamping hub and centering hub, connected via a bellows, in particular a folding bellows;

FIG. 2b shows a schematically illustrated enlarged partial longitudinal section of a connecting region between the clamping hub and centering hub;

FIG. 3 shows perspective views of an additional coupling comprising a clamping hub and a centering hub;

FIG. 4 shows a further exemplary embodiment in perspective view of a coupling comprising a clamping hub and a centering hub;

FIGS. 5a and 5b show two further exemplary embodiments of a clamping hub and centering hub, with corresponding radial torsional locking; and

FIGS. 6 and 7 show schematically illustrated perspective views of further exemplary embodiments of additional couplings comprising a clamping hub and a centering hub.

### DETAILED DESCRIPTION

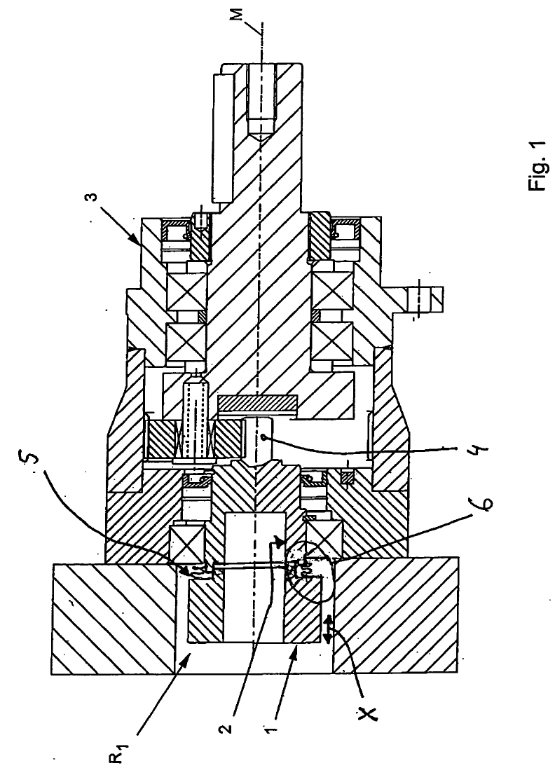

According to FIG. 1, a coupling R₁ according to the disclosure comprising a clamping hub 1 as a connecting element is inserted in a drive, electric motor, servomotor, or the like (not illustrated here in greater detail) and a transmission element 3.

The centering hub 2 is used for a matched-fit insertion into the transmission element 1 and for transmission of the torque to a spur pinion 4 of the transmission 3.

To compensate for axial expansion, in particular as the result of heating of the drive element, the clamping hub 1 is mounted so as to be slightly movable with respect to the centering hub 2 in the axial direction, in the illustrated double arrow direction X, along the center axis M.

The torque of any given drive is transmitted through the centering hub 1 via a bellows 5, in particular folding bellows 6, to the centering hub 2. The bellows 5, in particular folding bellows 6, which provides radial centering between the clamping hub 1 and centering hub 2, ensures that the torque from a possible axial compensation can be transmitted to the centering hub 2, in particular the spur pinion 4 of the transmission element 3.

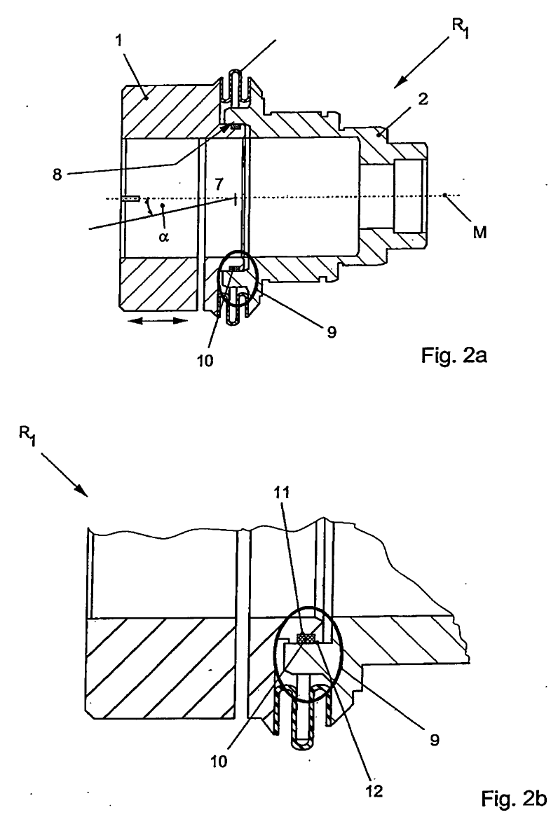

The coupling R₁ is illustrated in FIG. 2a in an enlarged longitudinal section. In an end-face area, in the region of the bellows 5 or folding bellows 6, the clamping hub 1 has a flange-like projection 7, outside a plug-in opening, which engages with a corresponding recess 8 in the centering hub 2.

In addition, the opposite case is also possible in which a projection (not illustrated or numbered here) from the centering hub 2 engages with a corresponding matching recess in the clamping hub 1 to prevent the clamping hub from being radially offset to the centering hub with respect to the center axis M.

It has proven to be advantageous in the present disclosure to insert an O-ring 10 in the region of a connection point 9 between the clamping hub 1 and centering hub 2 to ensure radial centering between the clamping hub 1 and centering hub 2.

The O-ring 10 may be inserted, for example, in an at least radially circumferential groove 11 in the projection 7.

However, the groove 11 may also be provided inside the recess 8 in the centering hub 2 in order to insert the O-ring 10 there. The disclosure is not limited hereto.

To ensure a slight angular swiveling or motion of the clamping hub 1 with respect to the centering hub 2, which is rigidly inserted in the transmission element 3, it has been proven to be advantageous to connect the clamping hub 1 to the centering hub 2 via the projection 7 and recess 8, with a slight amount of play, it being possible for an outer surface 12 of the projection 7 to have a convex curvature in the region of the groove 11, as illustrated in particular in FIG. 2b as an enlarged partial longitudinal section.

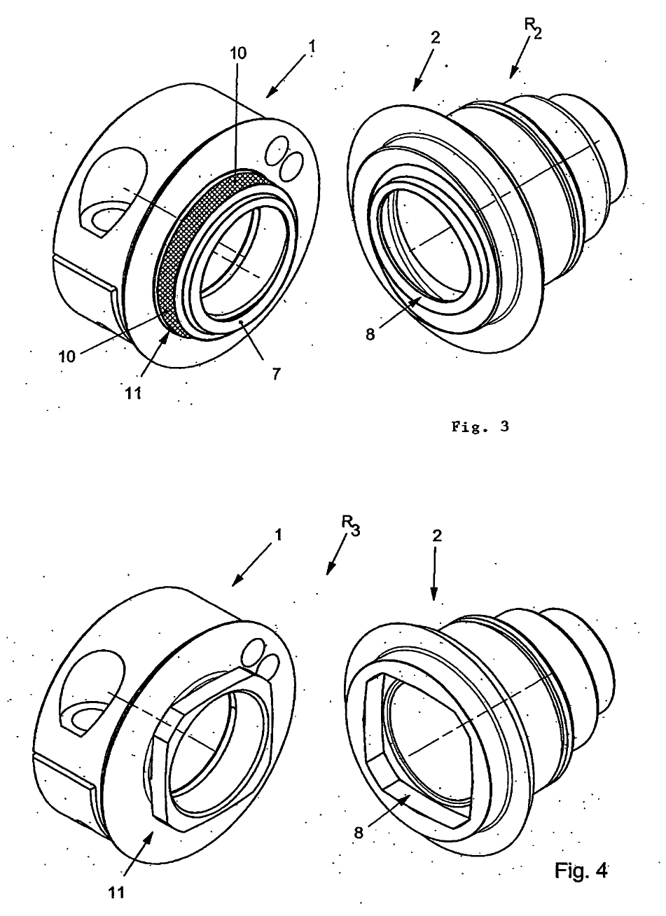

A corresponding perspective view of a similar coupling R₂ is shown in FIG. 3, with the clamping hub 1 and centering hub 2 shown in a perspective view. After the clamping hub 1 and centering hub 2 are joined or connected with a positive fit, the bellows 5 or folding bellows 6 is connected, in particular welded, thereto at a casing region between the clamping hub 1 and centering hub 2.

The perspective illustration in FIG. 3 shows that the projection 7 together with the groove 11 and inserted O-ring 10 projects in the end-face region of the clamping hub 1 and, when joined, engages with an exact alignment and positive fit into the corresponding recess 8 in the centering hub 2.

It has also been proven to be advantageous in the present disclosure, as shown for a coupling R₃, that in addition to the positive-fit connection between the clamping hub 1 and centering hub 2 the projection 7 is also designed with a polygonal shape as a polygonal, i.e., quadrangular, profile which, when the clamping hub 1 is joined with the centering hub 2, engages with a corresponding recess 8 in the centering hub 2. This ensures a radial offset as described above, and at the same time produces a positive-fit connection for transmitting a torque from the clamping hub 1 to the centering hub 2.

The projection 7 and the correspondingly matched recess 8 ensure additional radial torsional locking of the clamping hub 1 with respect to the centering hub 2. If, for example, the bellows 5 or folding bellows 6 (not illustrated here in greater detail) fails or ruptures as the result of overloading, for example, the correspondingly profiled projection 7 transmits the torque to the centering hub via the recess 8. The torque is then transmitted to the transmission element 3 via the positive-fit connection, thereby providing a so-called “fail-safe” function. The positive-fit connection thus serves as torsional locking, for example in the event of rupture or defect in the bellows 5, in particular folding bellows 6.

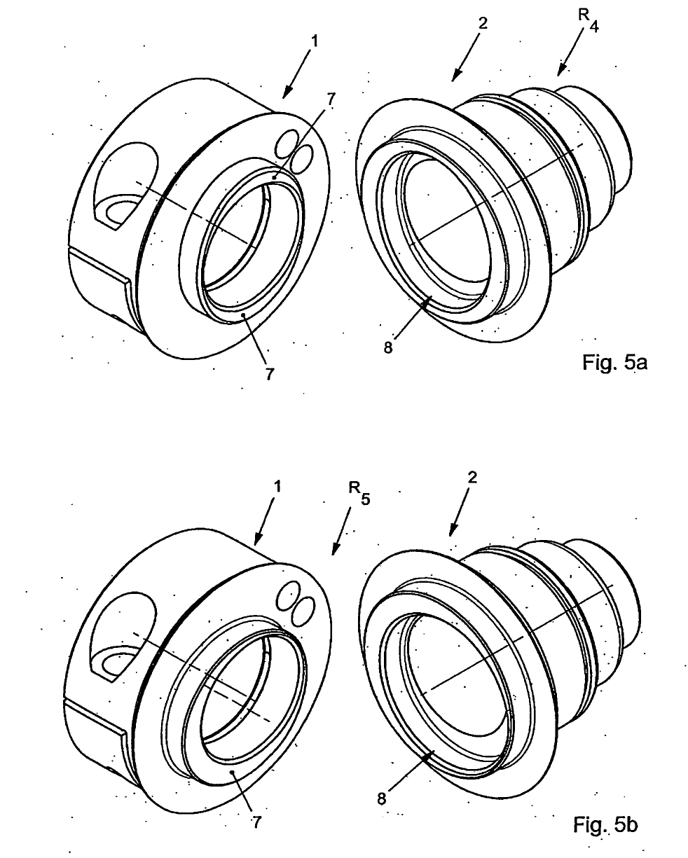

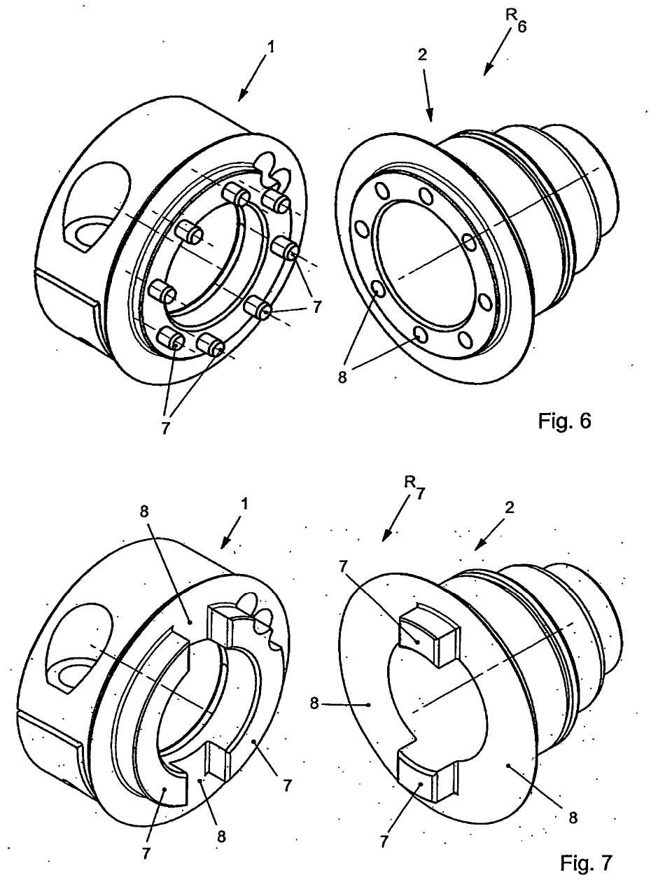

In the exemplary embodiment according to FIG. 5a, a coupling R₄ is illustrated which is also formed with a bellows 5 or bellows 6 (not illustrated here in greater detail) as described above, the clamping hub 1 and centering hub 2 being designed essentially as referenced above. In this case it has been proven to be particularly advantageous for the projection 7 to have an elliptical design as redundant, additional torsional locking, and to engage with an exact fit in a correspondingly matching, elliptically shaped recess 8 in the centering hub 2. If, for example, the connection, i.e., the bellows 5 (not illustrated here in greater detail), between the clamping hub 1 and centering hub 2 ruptures, the torque may still be present from the clamping hub 1 via the elliptically shaped projection, and still be transmitted to the corresponding elliptically shaped recess 8 in the centering hub 2 by positive-fit engagement.

Instead of the elliptical shape of the projection 7 or recess 8, an eccentric shape or configuration of the clamping hub 1 and centering hub 2 with respect to the center axis M is also possible, as illustrated in the exemplary embodiment of a coupling R₅ according to FIG. 5b.

As illustrated in the exemplary embodiment of a coupling R₆, it is also possible for projections 7 designed as pin elements to engage with corresponding recesses 8 designed as blind holes or the like to provide additional radial torsional locking. At the same time, this likewise ensures that slight axial motion is maintained as the result of the bellows 5 (not illustrated here in greater detail).

The respective projections 7 or pin elements also provide radial redundant torsional locking.

Instead of pin elements as projections 7, it is also possible to provide arbitrarily shaped projections 7 having correspondingly matching, substantially positive-fit recesses 8 in the end-face side between the clamping hub 1 and centering hub 2 for producing radial torsional locking, as indicated for a coupling R₇ in FIG. 7. The disclosure is not limited hereto.

1. A coupling for connecting two components comprising a clamping hub and a centering hub which are connected to one another in an axially displaceable manner by at least one bellows, wherein as additional torsional locking, the clamping hub and centering hub are connected with a positive fit and are radially locked torsionally with respect to one another.

2. The coupling according to claim 1, wherein the components comprise at least one of a drive element and/or a transmission.

3. A coupling for connecting two components comprising a clamping hub and a centering hub which are connected to one another in an axially displaceable manner by at least one bellows, wherein as an additional radial bearing the clamping hub and centering hub engage with one another with a positive fit, at least one O-ring being inserted as an additional radial bearing between the clamping hub and centering hub or between the centering hub and clamping hub to protect against lateral offset.

4. The coupling according to claim 3, wherein the components comprise at least one of a drive element and/or a transmission.

5. The coupling according to claim 1, wherein the clamping hub and centering hub are rigidly connected to one another by a bellows, in particular a folding bellows, and the clamping hub and centering hub are connected to one another in a radially rigid manner.

6. The coupling according to claim 1, wherein the clamping hub and centering hub engage with a positive fit by means of at least one projection from the clamping hub into a recess in the centering hub, or a projection from the centering hub into a recess in the clamping hub.

7. The coupling according to claim 6, wherein the projection from the centering hub and/or clamping hub comprises a pin element or as a flanged projection.

8. The coupling according to claim 6, wherein the recess is radially aligned with the projection of the clamping hub or the centering hub, and is designed as a blind hole or a slotted indentation.

9. The coupling according to claim 6, wherein the projection comprises a flange which protrudes from the end-face side of the centering hub or clamping hub, and engages with a corresponding, substantially matching and aligned recess provided in the clamping hub or centering hub.

10. The coupling according to claim 1, wherein both the projection and recess are situated eccentrically with respect to a center axis (M) of the centering hub and clamping hub, and/or have an elliptical design.

11. The coupling according to claim 6, wherein the projection on the clamping hub or centering hub which engages in alignment with the recess of the centering hub or clamping hub is designed as a polygonal profiled piece.

12. The coupling according to claim 11, wherein the projection is designed as a rectangular profiled piece.

13. The coupling according to claim 1, further comprising at least one groove for radial centering is provided in a projection from the clamping hub or centering hub, and in the groove an O-ring is inserted for radial centering of the radial offset, whereby engagement of the projection with the correspondingly matched recess in the clamping hub or centering hub protects the two components against radial offset with respect to one another.

14. The coupling according to claim 6, wherein a surface of the projection has at least a slightly convex curvature in the region of the at least one groove, thereby enabling a motion of the centering hub or clamping hub about an angle (α) of approximately 0° to 2° with respect to a center axis (M).

15. The coupling according to claim 1, wherein the clamping hub (1) and/or centering hub (2) and/or the bellows is associated with at least one sensor element to detect a rupture in the bellows, or to detect a friction fit between the clamping hub and centering hub in the region of the projection and recess.

16. The coupling according to claim 1, wherein the bellows is a folding bellows.

17. The coupling according to claim 15, wherein detection of a rupture in the bellows causes the mechanical torsional locking element between the clamping hub and centering hub to become engaged, and after a corresponding signal is detected by the at least one sensor element, the coupling (R₁ through R₆) and/or the bellows may be replaced if needed.

18. The coupling according to claim 17, wherein the torsional locking element is between the projection and recess.
